(19) United States
(12) Patent Application Publication
(10) Pub. No.: US 2019/0245635 A1
(43) Pub. Date: Aug. 8, 2019

(54) SINGLE-SOURCE CROSS-PLATFORM MEDIA MEASUREMENT ARRANGEMENT, DEVICE AND RELATED METHODS

(71) Applicant: Verto Analytics Oy, Helsinki (FI)

(72) Inventors: Hannu VERKASALO, Engelberg (CH); Timo SMURA, Helsinki (FI); Matti AKSELA, Jorvas (FI)

(73) Assignee: Verto Analytics Oy, Espoo (FI)

(21) Appl. No.: 16/320,552

(22) PCT Filed: Jul. 27, 2017
(86) PCT No.: PCT/FI2017/050558

§ 371 Date: Jan. 25, 2019

Related U.S. Application Data
(60) Provisional application No. 62/367,188, filed on Jul. 27, 2016.

(51) Int. Cl. H04H 60/31; H04H 60/33; H04H 60/37; H04H 60/46; H04H 60/51; H04H 60/66; H04L 29/08; H04M 15/00; H04N 21/442

(52) U.S. Cl. CPC H04H 60/31; H04H 60/33; H04H 60/37; H04H 60/46; H04N 21/44204; H04H 60/66; H04L 67/22; H04M 15/58; H04H 60/51

(57) ABSTRACT

Electronic arrangement for single-source cross-platform media measurements, comprising a communication interface arranged to receive observation data having regard to and at least partly determined at a plurality of electronic, preferably personal, devices of a number of users, at least one user of said number being associated with multiple devices of said plurality, said multiple devices belonging to mutually different technological platforms including online platforms for providing media exposure and the multiple devices comprising a usage meter to observe selected events indicative of device usage comprising media exposure, wherein the usage meter of at least one of the multiple devices being further arranged to observe user exposure to media on one or more external offline media distribution platforms, and at least one of the multiple devices being arranged to transmit observation data comprising indications of the observations towards the arrangement, at least one electronic database arranged to store the received observation data and user profile data linking the users with associated electronic devices, and an analyzer functionally connected to said database and arranged to operate on the data therein to determine at least one data file indicative of user-level media exposure metrics incorporating metrics describing the at least one user's behavior including media exposure on multiple platforms, said platforms comprising one or more offline platforms, and multi-platform usage sessions involving two or more simultaneously or sequentially utilized platforms. Related electronic device and methods are presented.

The invention relates generally to media measurements in connection with offline media as well as digital devices, communications, related applications, and services. Particularly, however not exclusively, the present invention pertains to a single-source cross-platform media measurement solution for measuring media exposure and related audience characteristics across different media channels.

### BACKGROUND

The evolution of digital media and Internet services such as web sites or web-accessible services is currently faster than ever. Both wired (e.g. desktop computers and smart TVs connected to the Internet) and wireless devices (e.g. tablets, phablets, laptops and smartphones) have already changed the way people access and engage with digital services, and as a result, both the related business and technological landscapes are encountering constant turbulence.

Primary stakeholders of the media industry and a majority of service developers, application developers and device manufacturers have recognized the need to understand the ongoing shift taking place in the media industry and the emerging new ways the people are exposed to, consume and access the related information in addition to the existing channels and practices.

Different electronic devices such as mobile terminals and tablets may be provided with downloadable, highly automated, user-wise somewhat transparent (i.e. running in the background automatically, whereupon no explicit user input/control is necessary) measurement software to log and forward data indicative of events occurred or detectable thereat and indicative of the services used, applications executed, etc. through the devices themselves.

However, the availability of multiple parallel digital, e.g. online, platforms for distributing media has also brought in corresponding new habits of consuming it without forgetting the quite considerable share of the overall media exposure the more traditional, e.g. offline, type media such as broadcast linear (scheduled) television, radio as well as set-box based MVPDs (multichannel video programming distributor) (live, DVR, VOD, etc.) utilizing RPD (return path data) still have. With ‘online media’ it is indeed typically referred to media distributed over the Internet whereas the aforesaid ‘offline media’ refers to the classic TV, radio and e.g. print media not utilizing the Internet as a distribution medium, i.e. being thus ‘offline’ from the standpoint of Internet distribution.

As a growing number of today's consumers own and actively utilize multiple media-enable devices such as mobile devices including e.g. a smartphone, tablet and smartwatch or some other wearable computer, both temporally parallel and sequential usage thereof has become fully feasible. Some of the device types or classes, such as smartphones, may further be technology-wise investigated in more detail using e.g. the underlying software platform, or OS (operating system), such as Android™ and iOS™, as additional distinguishing factor.

Accordingly, media exposure and usage behavior both in terms of individual sessions and general media and device usage is evolving. What has not been previously possible, the users may now, instead of sticking to e.g. a desktop computer, shift certain activities from current device (e.g. smartphone) to another device (e.g. a tablet), or the other device can prompt totally novel usage. In addition to online or more generally screen-based, or ‘on-screen’, interactions offline media channels such as radio or newspapers may be likewise consumed in parallel or sequence with other media.

Nevertheless, the total media exposure of a consumer may be thus split between a plurality of different media channels and related platforms, both online and offline, on-screen and off-screen, often involving simultaneous or e.g. alternating exposure on several of them. It is further evident that the existing versatile media platforms or media channels such as traditional offline over-the-air or cable-based radio/television and online media accessed through desktop/laptop computers or more portable mobile terminals, or even wearable devices, may generally reach different types of audience in different types of use contexts.

Reverting to the industry interest in cross-media measurements, e.g. application developers may be interested in improving the quality of activities that start on one device and continue on another device. In addition, mobile device vendors might value means facilitating understanding of mobile device usage through platforms to provide improved device designs in the usage. Still, offline media producers and distributors, and media industry in general including various advertisers, are certainly keen on understanding the consumer behavior in the realm of numerous simultaneously available media channels to optimize their efforts in terms of advertising campaigns and generally content delivery having regard to different user groups and their media usage behavior and preferences.

So far, most of the published media measurement solutions have been targeted to certain media platform such as television usage monitoring or mobile app usage measurements only, even often with relatively modest sample and reach having regard to the statistical representativeness thereof.

When multiple different source platforms for obtaining measurement data have been utilized, the approaches taken have typically been more or less isolated in terms of platform monitoring, whereupon also the results have lacked more comprehensive tracking of users' tendency to apply media on several devices either in parallel or sequentially.

Yet, some multi-platform or cross-platform studies capable of tracking cross-platform behavior of individual users have been executed e.g. having regard to online behavior in terms of smartphones, tablets and desktop/laptop computers, still excluding certain significant channels and media platforms such as radio and other non-screen media usage from the scope. The conducted analysis has also been limited due to the narrow focus and concise data of the studies in the first place. The technologies applied for gathering the source data for analysis have been laborious with reference to e.g. diaries and interviews requiring manual intervention from both the concerned interviewees or panelists and the experts conducting the study.

### SUMMARY

It is the objective of the present invention to at least alleviate one or more drawbacks or challenges relating to the existing prior art type media measurement solutions.

The objective is achieved by the various embodiments of an electronic arrangement, an electronic device and a method to be performed by one or more electronic devices, such as wired or wireless terminal devices, in accordance with the present invention.

In accordance with one embodiment, an electronic arrangement, optionally comprising a number of at least functionally connected servers, for single-source cross-platform media measurements, comprises
a communication interface arranged to receive observation data having regard to and at least partly determined at a plurality of electronic, preferably personal, devices of a number of users,

at least one user of said number being associated, preferably exclusively, with multiple devices of said plurality, said multiple devices belonging to mutually different technological platforms including online platforms for providing media exposure, e.g. smartphones, tablets, and/or desktop or laptop computers, and the multiple devices comprising a usage meter to observe selected events indicative of device usage comprising media exposure, wherein the usage meter of at least one of the multiple devices being further arranged to observe user exposure to media on one or more external offline media distribution platforms, such as offline radio or television, at least one of the multiple devices being arranged to transmit observation data comprising indications of the observations towards the arrangement,
at least one electronic database arranged to store the received observation data and user profile data linking the users with associated electronic devices, optionally anonymously, and
an analyzer functionally connected to said database and arranged to operate on the data therein to determine at least one data file indicative of user-level media exposure metrics incorporating metrics describing the at least one user's behavior including media exposure on multiple platforms, said platforms comprising one or more offline platforms, and multi-platform usage sessions, or ‘multi-sessions’, involving two or more simultaneously or sequentially utilized platforms.

In another embodiment, an electronic device, optionally online terminal device such as a smartphone, tablet, or computer of portable or desktop type, comprises
at least one sensor, such as a sound sensitive microphone, arranged to capture ambient data, such as sound signals, from the environment,
a usage meter to observe and log, e.g. in at least one log file, selected events indicative of device usage comprising media exposure taking place via the device, wherein the usage meter is further arranged to observe and log user exposure to media on one or more external offline media distribution platforms, such as offline radio or television, based on the sensor data, and
communication interface arranged to transmit observation data comprising the indications of the observations made and logged towards a remote arrangement over a communications connection, preferably wired or wireless network, e.g. Internet, connection.

An embodiment of a method for single-source cross-platform media measurements, to be performed by electronic arrangement comprising one or more at least functionally connected devices, such as network-connected servers, comprises

receiving, at the electronic arrangement, observation data, such as log files, having regard to and at least partly determined at a plurality of electronic, preferably personal, devices of a number of users,

at least one user of said number being associated, preferably exclusively, with multiple devices of said plurality, said multiple devices belonging to mutually different technological platforms including online platforms for providing media exposure, e.g. smartphones, tablets, and/or desktop or laptop computers, and the multiple devices comprising a usage meter to observe selected events indicative of device usage comprising media exposure, wherein the usage meter of at least one of the multiple devices being further arranged to observe user exposure to media on one or more external offline media distribution platforms, such as offline radio or television, at least one of the multiple devices being arranged to transmit observation data comprising indications of the observations towards the arrangement,

storing, in at least one electronic database, the received observation data and user profile data linking users with associated electronic devices, optionally anonymously, and

determining, by an analyzer functionally connected to said at least one database and arranged to operate on the data therein, at least one data file indicative of user-level media exposure metrics incorporating metrics describing the at least one user's behavior including media exposure on multiple platforms, said platforms comprising one or more offline platforms, and multi-platform usage sessions involving two or more simultaneously or sequentially utilized platforms.

Yet, the method may additionally or alternatively comprise:

capturing, by at least one sensor, such as sound sensitive microphone, of an electronic device, optionally a terminal device such as a smartphone, tablet, or computer of portable or desktop type, ambient data from the environment of the device,

observing and logging, by a usage meter of the electronic device, selected events indicative of device usage comprising media exposure taking place via the device, further observing and logging, e.g. in at least one log file optionally common with the indications of internal media exposure taking place via the device, indications of user exposure to media on one or more external offline media distribution platforms, such as offline radio or television, based on the sensor data, and

transmitting, by a communication interface of the electronic device, the logged data towards a remote arrangement over a communications connection, preferably wired or wireless network, e.g. Internet, connection.

Various considerations presented herein concerning the embodiments of the method may be flexibly applied to the embodiments of the arrangement and device mutatis mutandis, and vice versa, as being appreciated by a person skilled in the art.

The utility of the present invention depends on each particular embodiment and use scenario thereof. By the terminal, or generally, electronic device-based automated measuring of selected events indicative of user behavior and media exposure, for instance, a comprehensive large scale user panel of e.g. thousands or hundreds of thousands members in total may be rapidly and conveniently created from electronic device users such as mobile and/or desktop application users, wherein the application may be bundled with opt-in type observation software or logic. As one feasible implementation model, data of more rigorously controlled and typically smaller user panel (‘smart panel’) or group of panelists, which may have been specifically recruited utilizing e.g. initial survey to obtain the desired personal data such as demographic data and/or device ownership data, may be utilized and optionally selectively and cleverly combined with the data of a larger, less-controlled panel or group of panelists (‘boost panel’) to at least operatively establish an integral panel of considerable size. The data of the rigorously controlled panel may be utilized to complete the data of the larger panel when necessary.

Each user may have been associated with multiple electronic devices, optionally representing different platforms (e.g. online/offline type classification, device type based classification such as smartphone vs. tablet and/or operating system based, such as Android™ vs. iOS™, classification), in the arrangement. Each device, preferably at least each online device listed may have been provided with an embodiment of the usage meter to provide observation data to the arrangement. A single device may also be arranged to observe data on several platforms (e.g. internal online platform and external offline platform), i.e. different media platforms may be monitored using different observation techniques by a single device.

Thus, the measurements may be conducted in single-source cross-platform (multi-platform) fashion incorporating both online and offline media as the measuring electronic devices may be harnessed through audio matching, for example, to monitor also external signals indicative of offline media such as terrestrial radio or television exposure. In audio matching, ambient sound data may be first sampled, optionally with adaptive sampling frequency and/or bit depth, at the electronic device. Then, it may be matched, at the electronic device or remote system such as the arrangement described herein, against available reference data characterizing different content to determine what content type and/or which particular content item the user was exposed to.

In more detail, the measurements may cover cross-platform data involving desktop computers, laptops/notebooks, smartphones, tablets, phablets, wearable devices, vehicle electronics, e-book readers, television, radio and even printed media. Several of the monitored platforms may and will typically include display screen so that multi-screen monitoring becomes fully feasible in addition to ‘multi-platform’. The exposure to printed media may be either observed through the usage of its digital projections such as online or generally on-screen usage and/or by the analysis of sensor such as camera data indicative of traditional printed media usage or exposure, for example.

The offline data on e.g. TV and radio media exposure may be combined with internal data collected from the observing digital electronic device, optionally including location data, activity data (indicative of e.g. if the user is awake or present based on selected criteria such as accelerometer or other sensor signal, screen status, etc.), mobile/online behavioral data, etc. A plurality of data streams (data from within the-digital device, captured audio data, etc.) may be combined to log files that describe in a single-source fashion the consumer's media engagement with any media vehicle. Accordingly, data carriers such as data vector(s) may be established to exhibit the user's exposure to offline and/or in-device electronic content. A multitude of metrics describing user exposure to digital online media and non-digital offline media content may be established.

Selected metrics indicative of cross-platform usage and e.g. related switchovers between platforms, parallel/simultaneous usage, switchover trends based on e.g. the platforms themselves, media content, user characteristics, temporal factors (e.g. time of day, week, year), and/or geographical, or generally location, factors may be established. Further, the users may be analyzed in terms of demographics, platform-specific behavior such as smartphone behavior, tablet behavior, e-book behavior, and tv/radio behavior (networks/channels, programs such as shows or movies, ads), computer behavior (desktop/laptop), and/or purchasing behavior.

Detected parallel, sequential and isolated use of different media platforms and related media exposure are valuable factors in gaining understanding of causality or correlation between the users' activities such as online activity or purchase behavior.

Further having regard to analysis tasks executed on the data gathered from the electronic user devices, the present invention enables identifying the engagement of each user with any content, measuring his/her activity level, and basically tagging the observed events such as transactions with information distinguishing e.g. between home vs. out-of-home usage, i.e. location or other context related information. Multitasking sessions involving engagement in multiple media activities e.g. on multiple platforms may be analyzed as well as analytics built on second screen usage and interactions between the offline and online platforms, such as TV/radio and mobile/computer platforms. The incremental impact of any media vehicle or platform, along or together with other media channels, may be identified in driving the consumer and generally user behavior, e.g. ad recall or clicks.

The established single-source database(s) and metrics allow e.g. media companies or other relevant parties to understand, at an individual, still anonymized level, who is listening or watching and who is not, i.e. the reach and e.g. level of interest in, their ads or other content, and who is buying/not buying their products, etc. The analysis results may be converted into a number of control signals indicative of control actions to optimize the various aspects of media distribution (e.g. cross-platform campaign or generally media targeting) and e.g. device or application design as mentioned hereinbefore. In more general terms, the suggested solution enables linking users' exposure to media such as television advertising and promotion with their behavior such as purchase behavior or generally consumption behavior. Accordingly, the related optimization tasks are facilitated as being understood by a person skilled in the art. Also different communities including a group of people such as households or generally users living within a selected area, and/or having some common demographic or user ownership based characteristics, may be monitored based on its individual users through the present invention. Aggregate analysis may be conducted on the data of the users belonging to the same group, or ‘institution’, whereupon the potential optimization of media distribution or device design may also utilize the institutional data in addition to or instead of data of individuals.

Additional benefits of the embodiments of the present invention will become clear to a skilled reader based on the detailed description below.

The expression “a number of” may herein refer to any positive integer starting from one (1), e.g. one, two, or three.

The expression “a plurality of” may refer to any positive integer starting from two (2), respectively.

The terms “first” and “second” do not denote herein any particular order or importance, unless explicitly stated otherwise, but rather these terms are used to distinguish one element from another.

The expression “panel” may refer herein to a specific, intentionally recruited sample of users of electronic devices (or the devices themselves), i.e. “panelists”, providing data on the desired aspects such as media usage taking place in connection with the devices. In addition or alternatively, the “panel” may refer to basically any other applicable sample of users/devices, i.e. not necessarily the aforementioned particularly set up special panel of dedicated panelists, which is adapted to provide data having regard to the metered aspects. For example, a plurality of end-users of one or more apps downloaded from an app store could constitute at least part of such panel, when the apps have been provided with feasible metering software capable of capturing selected data considered relevant.

Different embodiments of the present invention are disclosed in the attached dependent claims.

### BRIEF REVIEW OF THE DRAWINGS

Few embodiments of the present invention are described in more detail hereinafter with reference to the drawings, in which

FIG. 1 illustrates few embodiments of an arrangement and electronic device in accordance with the present invention in connection with a potential use scenario.

FIG. 2 depicts session such as multi-session analysis aspects of the present invention in accordance with an embodiment thereof.

FIG. 3 is a block diagram representing the internals of an embodiment of the arrangement.

FIG. 4 illustrates different events the cross-platform monitoring solution in accordance with an embodiment of the present invention is capable of detecting and logging for analysis.

FIG. 5 illustrates the concept of the suggested single-source measuring approach and related aspects for providing insight into the user's behavior including device and media usage.

FIG. 6 shows infographic of the utilized measurement methodology in accordance with an embodiment thereof.

FIG. 7 is a flow diagram disclosing an embodiment of a method in accordance with the present invention.

### DETAILED DESCRIPTION

In various embodiments, one or more of the multiple devices provided with usage meter may be online devices, i.e. functionally connectable to the arrangement via the Internet. In some embodiments, at least one device containing at least limited metering features may be functionally connected, e.g. via short-range wireless connection such as Bluetooth™ or wireless LAN (WLAN) to other device having the necessary network connectivity for passing data forward. The other device may also have the metering feature installed and in use. The other device may optionally process and/or combine the locally obtained data and data from external device.

In various embodiments, the observations that may be made and logged in the electronic devices comprising the usage meter, indicate the usage of at least one element selected from the group consisting of: application, native application, web application, service, web, web site, web page, Internet, network, device feature, terminal feature, application feature, service feature, media or generally content item, file, media streaming, phone usage, call (e.g. voice or video), message, time, location, operating system, purchase or other financial transaction, data transfer, and HTTP (Hypertext Transfer Protocol) or HTTP(S) data transfer. Different aforesaid elements such as time may be indicated in a variety of ways having different resolution or contextual meaning, considering e.g. clock type scalar and more measurement like representation of time or e.g. ‘time of day’ type more relational representation (morning, noon, afternoon, evening, night, etc.).

In various embodiments, the usage meter may comprise or be at least functionally connected to at least one sensor such as an audio transducer and/or camera (image sensor) for image or video reception. The audio transducer typically includes a sound microphone to capture e.g. ambient sounds emanating from near-by sound sources such as a radio, television, or sound reproduction system of some indoor or outdoor location, e.g. mall or transportation node where e.g. audio commercials may be audibly reproduced in addition to possible informative announcements. Yet, image/video data from e.g. digital signage screens may be captured. The captured sensor signal such as a digitalized audio signal may be then subjected to analysis to characterize the associated user activity and/or media exposure. The analysis may be performed at the capturing device and/or by the arrangement based on the data provided by the device.

For example, the type of the associated media distribution platform, such as radio or television, may be generally detected based on the signal. Yet, the actual media or generally content item such as a commercial, program (e.g. ‘Morning news’), the related channel or network (e.g. ‘Channel 5’ or ‘MTV’), etc. may be identified or at least classified (e.g. entertainment, weather, documentary, etc.). For the detection, classification and/or identification purposes, a recognition algorithm, optionally a matching algorithm, may be executed. In terms of digital sound signal or representative data derived therefrom, e.g. audio matching may be performed. For video or image data, image-based matching could be performed. Several media formats could be also collectively matched using a combined matching algorithm.

A reference library comprising reference data, or ‘fingerprints’, characterizing different media entities, such as media platforms/channels, included program channels/networks, programs, commercials, other content items, etc. may be established and utilized in the procedure. Data for the reference library or at least part of the library itself may be received from various media sources such as television station, radio station, content producers such as record labels or production companies, etc.

Additionally or alternatively, a selected speech detector and/or speech recognizer unit, or algorithm, may be arranged to extract the presence of speech type data from the signal with reference to the former and/or speech content related data such as text and/or semantic information determined from the recognized speech, with reference to the latter type of a unit or algorithm.

Other examples of sensors that may be harnessed into providing observation data include image sensor, or ‘camera’, accelerometer or other inertial sensor, light sensor, temperature sensor, pressure sensor, moisture sensor, location sensor and touch sensor.

In some embodiments, a recognition algorithm such as the one described above based on matching may be arranged to analyze image data shown on the display of the electronic device to identify the related content. The outcome of the recognition procedure may be then logged and signaled to the arrangement if not directly executed therein based on the digital image provided by the electronic device.

In various embodiments, the indications of the observations may incorporate the observed data itself, e.g. network event details, user input details, application details, media file details, and sensor data, and/or data extracted or derived such as processed therefrom through data processing or handling tasks incorporating e.g. filtering, aggregating, analysis (feature extraction or classification, for example) and/or compressing. Data vectors may be established already in the observing electronic devices and/or afterwards e.g. by the arrangement to spare storage space and/or transmission bandwidth. Additionally or alternatively, the observed data may have been linked or enriched with related available contextual data or metadata such as time or location information.

In various embodiments, contextual data such as location data (e.g. mobile or computer network based positioning data or satellite based positioning data such as GPS positioning data) received or determined by the electronic devices or network entities such as the arrangement may be utilized to add contextual information to the metrics. The reported locations as indicated by the data may be converted into or generally utilized in determining other information such as movement information and/or contextual location information (e.g. certain bar or other public place, home/out of home, etc.) through the use of mapping data that links e.g. coordinates or other positioning data with contextual position. Such mapping data may be established based on e.g. digital address books or other address data associating contextual entities such as businesses, public places, etc. with physical locations.

In various embodiments, all or selected Allen time interval relations of Allen's Interval Algebra may be utilized in determining and examining multi-device and generally multi-platform usage based on observation data. A usage session associated with an electronic device, such as application usage session taking place in a smartphone or exposure to offline media such as terrestrial radio program, may be defined as a time period of application usage or radio broadcast exposure, respectively, with clear start and end times, which maps well to Allen's notion of finite time interval.

Several sequential app, or generally, media, content and/or other monitored usage sessions on a device may be grouped into a single device usage session. Accordingly, by the utilization of the relations, the temporal relationships between usage sessions of one or more devices may be duly formalized.

In various embodiments, the analyzer may be arranged to establish mutually similar, in terms of e.g. statistical comparisons, user-level metrics on multiple different platforms such as offline media distribution platforms (terrestrial, cable or satellite radio or television, for example) and/or different (online) technological platforms underlying the electronic devices comprising an instance of the usage meter (e.g. tablet, smartphone, desktop computer, laptop computer, wearable device and/or game console).

In various embodiments, the analyzer may be arranged to link, e.g. in said at least one data file or at least temporarily during analysis, a media event with the device in which or through which the user was exposed thereto. Accordingly, a content item associated with the media event, such as application, web page, advertisement or audio/video file, may be attributed to the particular, relevant device in question.

In various embodiments, the data file determined by the analyzer may include abstractions such as more general metrics on top of user-level data. For example, the overlap between the usage of media consumption e.g. on different platforms (e.g. smartphone/mobile terminal, tablet, computer) may be determined. The overlap of usage of several platforms may be investigated temporally and/or having regard to the content or media exposure. Causality explaining metrics may be determined. For instance, the relationship between the usage of certain application or service (e.g. Facebook™) on certain platform and the usage or exposure to same or similar, different, or just generally media on some other platform such as offline media distribution platform (e.g. television or radio) may be determined. As a further example, the relationship of device usage, preferably incorporating at least media exposure, on one platform such as offline platform (considering e.g. ad on television) and usage of different, e.g. online, platform (such as Twitter™) could be determined.

In various embodiments, the data file or at least portion of the included metrics may be utilized to determine a number of control signals. The control signals may be used to adapt content such as application, service, or related media item that is or is to be accessed, used and/or consumed through the electronic devices or offline media distribution platforms. Additionally or alternatively, e.g. timing of content, such as broadcasting time of an advertisement, may be optimized or selected responsive to the control signals. Yet, the platform(s) (e.g. online platforms, such as Android™, iOS™ or Windows™, or offline media distribution platforms such as radio or television) of content may be selected responsive to the control signals.

The data files, which refer to collections of data preferably following a selected proprietary or standard format (e.g. database or application format) represent deliverables that may be output from the arrangement via the data communication interface. The arrangement may be provided with a local and/or remote UI (user interface). The remote UI may incorporate e.g. a web (Internet) based graphical UI for use with a browser accessed in a remote terminal. At least part of the data in the data files may be visually represented via the UI. The arrangement may optionally host a web server for the purpose or external web server may be used.

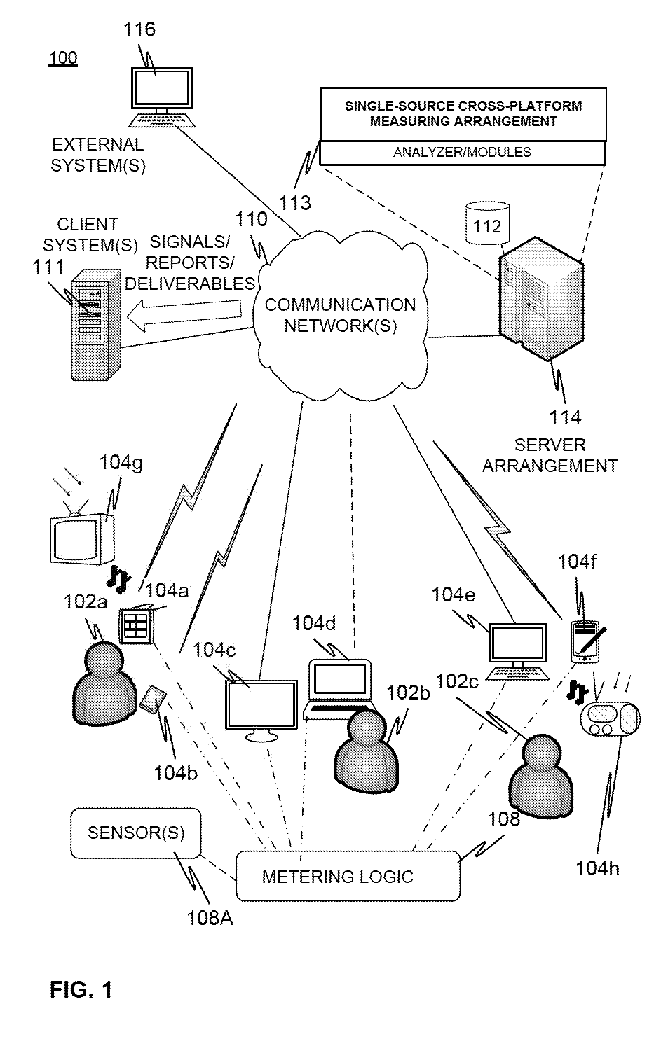

FIG. 1 shows, at 100, one merely exemplary use scenario involving an embodiment of an arrangement 114 in accordance with the present invention and few embodiments 104a, 104b, 104c, 104d, 104e, 104f of electronic devices in accordance with the present invention as well. The devices 104g (television) and 104h (radio) are examples of external ‘offline’-type media distribution platforms that may still be observed in terms of media output by the usage meters of preferably online type electronic devices 104a-104f. A device generally refers to a physical device e.g. with a certain brand, model and device characteristics including media access or reproduction capabilities.

A single user 102a, 102b, 102c may own, use, access, be exposed e.g. in terms of media output, or be otherwise associated with one or several online and/or offline devices. One or more of such devices, preferably of at least electronic devices 104a-104f, may be or be at least considered personal, i.e. at least primarily used by a single person such as the owner only and/or enabling identification of the current user based on e.g. authentication or login data such as credentials. Accordingly, the obtained usage or exposure data may with high likelihood relate to that particular single user only so that also the determined cross-platform metrics are valid from the standpoint of single-source, user-level analysis objective.

The users 102a, 102b, 102c are generally representative of at least certain share of overall population depending on the panel recruitment policy and e.g. related demographic goals.

Network 110 may refer to one or more communication networks such as the Internet, local area networks, wide area networks, cellular networks, etc., which enable terminals 104a-104f and server arrangement 114 to communicate with each other.

The arrangement 114 may be implemented by one or more electronic devices such as servers and potential supplementary gear such as a number of routers, switches, gateways, and/or other network equipment. In a minimum case, a single device such as a server apparatus is capable of executing different embodiments of the method and may thus constitute the arrangement 114 as well. At least part of the devices of the arrangement 114 may reside in a cloud computing environment and be dynamically allocable therefrom.

The devices 104a, 104b, 104d, 104f may refer to mobile terminals such as tablets, phablets, smartphones, cell phones, laptop computers or desktop computers, for instance, but are not limited thereto. The users (panelists) 102a, 102b, 102c may carry mobile devices 104a, 104b, 104f along while heavier or bulkier devices 104c, 104e often remain rather static if are not basically fixedly installed. Each device may support wired and/or wireless network connections. For example, wired Ethernet or generally LAN (local area network) interface may be provided at least in some devices 104c (smart tv), 104e (desktop computer) whereas the remaining devices 104a (tablet), 104b (smartphone/cellular phone), 104f (e.g. phablet, e-book reader or wearable device) may dominantly support at least cellular or wireless LAN connections.

One or more of the online devices 104a-104f, potentially all of them depending on e.g. the configurability of the devices and capability and capacity to install and run observation logic-executing software, may indeed be provided with usage meter, or ‘metering’ logic, 108 e.g. in the form of a computer (processing device) executable software application via a network connection or on a physical carrier medium such as a memory card or optical disc. The software may be optionally bundled with other software. The user may opt-in to install the meter and thus participate in the measuring study as a panelist, for example. The logic is configured to log data on selected events taking place therein. The data may be transmitted e.g. in batches to the arrangement 114 for processing, analysis and/or storage in the light of desired media measurements. The transmissions may be timed, substantially immediate following the acquisition of the data, and/or be based on other predefined triggers.

In some embodiments, the obtained data may be subjected to at least some analysis already at the terminals 104a, 104b, 104c, 104d, 104e, 104f. For example, a number of characteristic vectors may be determined therefrom. The vectors may be stored and transferred forward to the arrangement 114.

Preferably the meter 108 acts in the background so that any user actions are not necessary for its execution, and the logic may actually be completely transparent to the user (by default not even visually indicated to the user, for example).

Yet in some embodiments, a number of external systems 116 may provide data to the arrangement 114. For example, third-party apps distributed by the systems 116 of third-party app developers may be arranged with metering software (observation logic) that collects measurement data useful to the panel study. The data may be provided from the apps to the arrangement 114 optionally via the developers' systems 116.

The server arrangement 114 comprises or is at least functionally connected to a data repository 112, such as one or more databases, configured to store data such as data obtained from the electronic devices 104a-104f, data from external systems 116, etc.

The arrangement 114 is arranged to determine a number of selected, e.g. client-selected, deliverables such as media coverage or reach statistics, behavioral metrics, control signals, or cross-platform media exposure metrics to be distributed to a number of client systems 111. As the preferred method of measurement is of single-source multi-platform type, the determined metrics may really be user-level in a sense they also capture individual users' cross-platform usage and exposure characteristics in contrast to solutions where different platforms are measured in isolation.

The arrangement 114 comprises a number of different functional modules 113 such as analysis, classification, validation, data ascription and/or reporting modules. The validation module may be configured to execute different validity analysis/filtering tasks at one or more stages of the panel data acquisition and cultivation process, e.g. activity validation to determine initial group of panelists having regard to a reporting period and subsequent validity analysis/quality assurance operations filtering the panelists based on their data reliability or probability.

Some of the electronic devices 104a-104f may be arranged to monitor external offline media 104g, 104h using e.g. ambient audio analysis as being described hereinbefore. The devices 104a-104f may contain a number of sensors 108A, e.g. a microphone, for gathering data on the environment, for instance. The observation and logging of related external events, or user exposure to external (offline) media 104g, 104h, may take place in addition to observing internal events taking place within the device itself and/or at least relating thereto via data transfer or user activity, for example.

Some of the electronic devices 104a-104f may be arranged to log data of another online type device 104a-104f or e.g. so-called accessory device wirelessly or wiredly communicating with the logging device. The accessory device may contain e.g. sensors capable of observing selected usage or exposure data with reference to e.g. a headset, other wearable accessory (e.g. wristop device) or a microphone and related circuitry including a/d converter.

Some of the electronic devices 104a-104f may have been arranged to potentially inherently support multiple different technical media distribution platforms such as online media (e.g. web site or page) and offline media (e.g. broadcast terrestrial linear radio, television). The devices may contain e.g. dedicated transceivers or receivers for such platforms. Accordingly, each such device of certain basic technological platform or device class (e.g. tablet, potentially in particular Android™or e.g. iOS™ driven tablet) may detect and log events indicative of device usage, specifically media exposure, on multiple media distribution platforms.

Through data processing and related abstraction procedures, the arrangement 114 is configured to create similar user-level metrics regarding user behavior on multiple fundamentally different platforms such as different media distribution channels (various online and offline platforms) and different terminal technologies or classes that may still be capable of receiving or accessing mutually similar media content (smartphones, tablets, desktop computers, laptops, wearable computers, etc.). The different platforms may be measured with different type of measurement approaches with reference to e.g. audio matching for TV media exposure vs. (native) app usage tracking on mobiles vs. HTTP traffic tracking on desktop computers/‘PCs’, i.e. personal computers.

With the built multi-session metrics and abstractions on top of the gathered user-level media exposure data, causalities and correlations in cross-device and cross-platform usage, such as simultaneous usage, sequential usage and related switchovers, may be detected and analyzed through the selected metrics, for instance. Overlap between one media consumption with other media consumption may be determined. The metrics that explain causality—e.g. is Facebook™ mobile usage affecting how people watch television, or is a television ad driving how people communicate on Twitter™, may be detected and subsequently potentially utilized in device, application and/or media campaign design.

Still, with the multi-device framework of observing electronic devices and the data aggregation and analysis arrangement established with information on device activity, the attribution of any detected audio/video or generally media or content exposure event to a particular device may be performed utilizing a number of selected rules. Accordingly, when inspecting a hit for certain content indicative of e.g. television program, it can be attributed to a mobile device, linear TV, VCR (time-shifted content), or e.g. desktop or laptop computer, for instance.

Contextual data such as location data may be utilized to add contextual understanding to selected media consumption metrics. Again, different related correlations and causalities may be investigated and detected. For example, it may be determined whether the users are generally on the move when they consumer music streaming on their mobile, or are they watching TV in a bar (out of home) vs. at home.

Depending on the properties of the sample, such as scope and availability of calibration data, the obtained results such as metrics derived based on the observation data at the arrangement 114 may be computationally stretched to cover or describe a larger population, e.g. certain region, state, country or otherwise broader userbase of electronic devices, media, etc.

In some embodiments, the users 102a, 102b, 102c may be allocated to different user groups, or panels, from the standpoint of the suggested measurement system including the devices 104a-104h and the arrangement 114. As mentioned hereinbefore, e.g. a more rigorously controlled and thus more complete and/or more verified data containing but usually smaller ‘smart’ panel of first group of users and a more loosely constructed but potentially considerably larger ‘boost’ panel of second group of users may have been established.

The incomplete, missing or faulty data of a boost panelist may be in some embodiments completed based on the data of a number of smart panelists considered similar, based on the existing common data, to the boost panelist according to the selected criteria.

Several at least conceptually different panels may be then combined to establish a joint panel for the analysis and determination of the deliverables in the form of one or several data files.

In some embodiments, a number of virtual panelists may be created (modeled) to a panel, e.g. the boost panel in the case of several panels. The virtual panelist may refer to a typical panelist in the light of the arrangement computationally generated based on the data of existing physical (real-life) panelists utilizing a selected data ascription model.

In some embodiments, the observations may be targeted to a certain time period at a time, which may refer to a so-called reporting period, such as a day, week, month or year. The panelists (users) may be subjected to a validation procedure having regard to the reporting period based on which the data of some panelists, i.e. data provided by the associated devices, are selected and the rest are disregarded in the analysis and/or resulting deliverables such as metrics provided in the data file. Positive outcome of the validation procedure, which may be implemented as a filtering task, may require e.g. detected activity of the user prior to, during, and/or after the reporting period (preferably all these three). The activity may be monitored based on the observation data obtained from the devices associated with the user. Additionally or alternatively, the positive validation may require sufficient and/or sufficiently correct data obtained from the device(s).

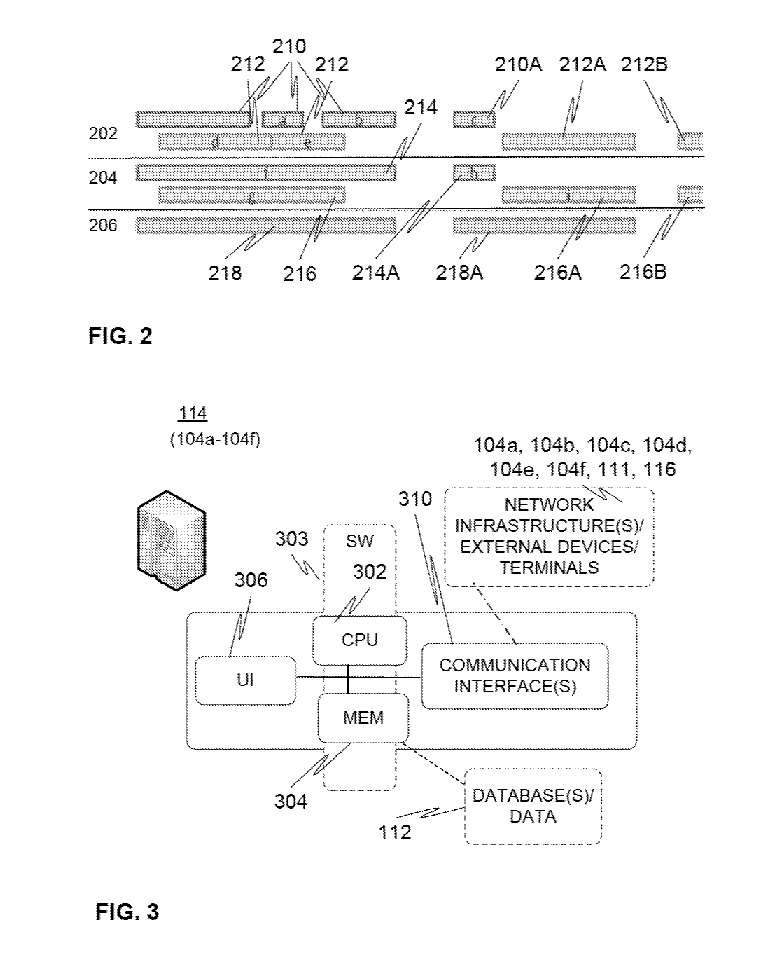

FIG. 2 depicts session such as multi-session analysis aspects of the present invention in accordance with an embodiment thereof. In the figure, time proceeds from left to right.

To determine and analyze multi-sessions (multi-platform/multi-device) in connection with various embodiments of the present invention, a desired approach for defining the sessions may be first selected. Allen's thirteen basic time interval relations are the building blocks of Allen's Interval Algebra. The relations are distinct (a pair of intervals are described by one and only one relation), exhaustive (any pair of intervals can be described by one of the relations) and qualitative (no numeric time spans are required). The relations are: precedes, meets, overlaps, finishedBy, encloses, starts, equals, startedBy, enclosedBy, finishes, overlappedBy, metBy, and precededBy. Intuitively, six of the relations can be described as converses of the six other relations. For example, the converse of a meets b (interval a occurs first and at the end of a, interval b seamlessly begins) is b metBy a (b occurs first followed by a at the end of b). If there's some time between the intervals a and b (i.e. not immediate switchover), the corresponding relations are precedes and precededBy.

In the context of various embodiments of the present invention, e.g. an application session can be defined as a period of application usage with a clear start and end time. This type of session is equivalent to Allen's notion of a finite time interval. Thus, we can utilize Allen's relations in determining and examining multi-device usage. The relations formalize the temporal relationships between (usage) sessions of one or more devices.

In more detail, we may define e.g. app or other content or media session as a time interval indicative of exposure starting with the application (/content/media) moving to the foreground of the device and ending with it moving out of the foreground (either replaced by a different app/content/media or e.g. screen off), for instance. We may further define a single device usage session as a collection of such sessions on a single device with a maximum selected timeout value (e.g. few minutes or less, where the temporal resolution of timeout adjustments may be one second, for example) between two sequential app sessions.

Since by definition single device app sessions are sequential, only precedes and meet of Allen's relations (and their respective converse relations) are applicable. If two app sessions meet, the sessions will belong to the same usage session. If an app session precedes or is precededBy another app session within the maximum timeout time window, then the app session will also belong to the same usage session. Henceforth, we denote this relation as precedes (precededBy) within such time window (abbreviated as precedes (precededBy) within TW). Thus through a combination of these four relations multiple app sessions can be grouped into single device usage sessions.

For multiple devices of a user basically all Allen's relations are applicable. As explained above, precedes and meet (with their respective converse relations) describe sequential usage, while the remaining relations describe at least partly, i.e. overlapping, simultaneous usage of the devices.

For constructing a multi-device usage session we may follow a two-step process. First, we apply e.g. the above single device usage session definition separately for each device. Second, we examine the relations of the usage sessions of the multiple devices. If the single device usage sessions are at least partly simultaneous (overlaps (converse: overlappedBy), finishedBy (finishes), encloses (enclosedBy), starts (startedBy), equals), or they meet (are metBy) or precede (are precededBy) within TW, they are considered belong to the same multi-device usage session.

FIG. 2 illustrates this process with sessions of two devices, e.g. smartphone and tablet. Horizontal bars represent sessions on different levels of session hierarchy.

Top level sessions 202 may be most detailed, e.g. application level or generally content or media, sessions. The intervals 210, 210A represent in total four sessions on a first device, with the last three of them being named as a, b, and c for illustration purposes from the standpoint of forthcoming example.

The intervals 212, 212A, 212B represent four sessions on a second device, with the first two being named as d and e.

Level 204 refers to single device usage sessions. Usage sessions of level 202 have been combined to sessions f 214 and h 214A having regard to the first device and sessions g 216, l 216A and the one 216B extending out from the visible timeline having regard to the second device.

So what has been done during the processing step between levels 202, 204 is the application of usage session definition to each device's app sessions.

Subsequent abstraction level 206 refers to multi-device usage sessions 218 and 218A. During the processing step between levels 204, 206, the simultaneous, meeting and preceding within time-window usage sessions have been ‘collapsed’ or merged into multi-device usage sessions.

Having regard to Allen's relations, in the shown scenario e.g. interval a precedes within TW b; b precedes c; d meets e; f encloses g; and h precedes within TW.

The user has thus been involved either one or more devices at a time (or maximally having a break of TW length in between sequential sessions on a device with reference to e.g. integral interval f 214 constructed from temporally non-integral, i.e. distinct, intervals 210) during the multi-device usage session.

The concept of availability could be further defined. Given two devices A and B, we could define device B as available for use, relative to device A, if the devices are co-located during a usage session of device A. In other words, the user could have used device B instead of device A assuming e.g. similar application(s) on both devices. The devices may be considered as co-located if they are geographically (based on e.g. satellite positioning data such as GPS (Global Positioning System) and/or network positioning data, e.g. cell-ID or network/IP (Internet Protocol) address) in the same location according to selected criterion. For example, two devices may be deemed to be in the same location if e.g. the squares centered on the (latitude, longitude) GPS points with width of selected times, e.g. two times, the accuracy of the GPS measure reported by each device intersect.

Yet, different session types could be defined and then detected based on the observation data to facilitate analysis and making it more versatile and descriptive. For instance, each single device usage session (and by extension e.g. each app session contained within a session) could be classified along multiple, potentially three distinct binary dimensions such as device type (smartphone or tablet), containment in a multi-device usage session (if contained in a multi-device session then mixed or if not, then pure), and the availability of other device (available or unavailable).

The determined session or generally usage or media exposure information may indicate at least one element selected from the group consisting of: session length, number of platform switchovers during session, application sessions per device session, sessions per selected time window, sessions per day, interaction time per time window, interaction time per day, platform switchover parties, platform switchover direction, platform overlap, simultaneous usage of smartphone and tablet, simultaneous usage of two or more different technological platforms, simultaneous usage of online and offline platform, purchase behavior, and switchover between offline and online media.

User-level and/or aggregate level information describing a larger group of users may be determined.

In addition to media exposure having regard to platforms and related sessions, media or content items themselves may be identified and/or classified, which may be valuable analysis data for different entities such as media companies, advertisers, etc. For example, computer (desktop/laptop and/or mobile) applications may be allocated into a plurality of classes such as shopping, health, productivity, maps and navigation, entertainment and sports, camera, weather, photos and gallery, e-books, games, finance, social networking, music and audio, video, and news. Some classes may have overlap depending on the used classification scheme. Accordingly, from the metered data, metrics regarding the media/content items and e.g. their classification or related switchovers may be determined.

FIG. 3 is a block diagram representing the internals of an embodiment of the arrangement 114. Similar considerations are mainly applicable also to various embodiments of the electronic devices 104a-104f as set forth hereinbelow.

The arrangement 114 may be physically established by at least one electronic device, such as a server computer. The system 114 may, however, in some embodiments comprise a plurality of at least functionally connected devices such as servers and optional further elements, e.g. gateways, proxies, data repositories, firewalls, etc. At least some of the included resources such as servers or computing/storage capacity providing equipment in general may be dynamically allocable from a cloud computing environment, for instance.

At least one processing unit 302 such as a microprocessor, microcontroller and/or a digital signal processor may be included. The processing unit 302 may be configured to execute instructions embodied in a form of computer software 303 stored in a memory 204, which may refer to one or more memory chips or memory units separate or integral with the processing unit 302 and/or other elements. The software 303 may define e.g. one or more applications, routines, algorithms, etc. for observation data processing and deriving of different output files such as digital reports to clients 111 as deliverables. A computer program product comprising the appropriate software code means may be provided. It may be embodied in a non-transitory carrier medium such as a memory card, an optical disc or a USB (Universal Serial Bus) stick, for example. The program could be transferred as a signal or combination of signals wiredly or wirelessly from a transmitting element to a receiving element such as the arrangement.

One or more data repositories such as database(s) 112 of preferred structure and storing e.g. the received observation data, intermediate analysis results, reference data, deliverables, etc. may be established in the memory 304 for utilization by the processing unit 302. The repositories may physically incorporate e.g. RAM (Random-Access memory) memory, ROM (Read-Only Memory), Flash, magnetic/hard disc, optical disc, memory card, etc.

A UI (user interface) 306 may provide the necessary control and access tools for controlling the arrangement (e.g. definition of library or generally data management rules or the data analysis logic) and/or accessing (visualizing, distributing) the data gathered and derived. The UI 206 may include local components for data input (e.g. keyboard, touchscreen, mouse, voice input) and output (display, audio output) and/or remote input and output optionally via a web interface, preferably web browser interface. The system may thus host or be at least functionally connected to a web server, for instance.

Accordingly, the depicted communication interface(s) 310 refer to one or more wired and/or wireless data interfaces such as wired network (e.g. Ethernet) and/or wireless network (e.g. wireless LAN (WLAN) or cellular) interfaces for interfacing a number of external devices and systems with the system of the present invention for data input and output purposes, potentially including control. The arrangement 114 may be connected to the Internet for globally enabling easy and widespread communication therewith. It is straightforward to contemplate by a skilled person that when an embodiment of the arrangement 114 comprises a plurality of functionally connected devices, any such device may contain a processing unit, memory, and e.g. communication interface of its own (for mutual and/or external communication).

The electronic (terminal) devices and/or external devices/systems directly or indirectly connected to the arrangement 114 for providing data thereto or obtaining data such as deliverables therefrom, may generally contain at least functionally similar hardware elements such as processor 302, memory 304 and communication interface 310. Preferably, in particular the user devices in possession of panelists, such as various preferably personal terminals, may be equipped with a usage meter for gathering data on media usage of the panelist. The metering logic may be configured to log data on a number of potentially predefined events, occurrences, measurements and provide the log forward towards the arrangement either directly or via different host application systems when bundled with other software, for example.

The electronic devices may include one or more sensors to gather data on the context and/or environment of the device and thus also the associated user (when these two are considered to remain spatially close). For example, an inertial sensor such as accelerometer may be utilized to obtain e.g. movement or motion context, or generally activity, data, whereas microphone may be harnessed into capturing ambient sounds indicative of e.g. offline media exposure or of e.g. location or activity context (e.g. discussion, movie theatre, meeting, sleep, transportation/vehicle, etc.).

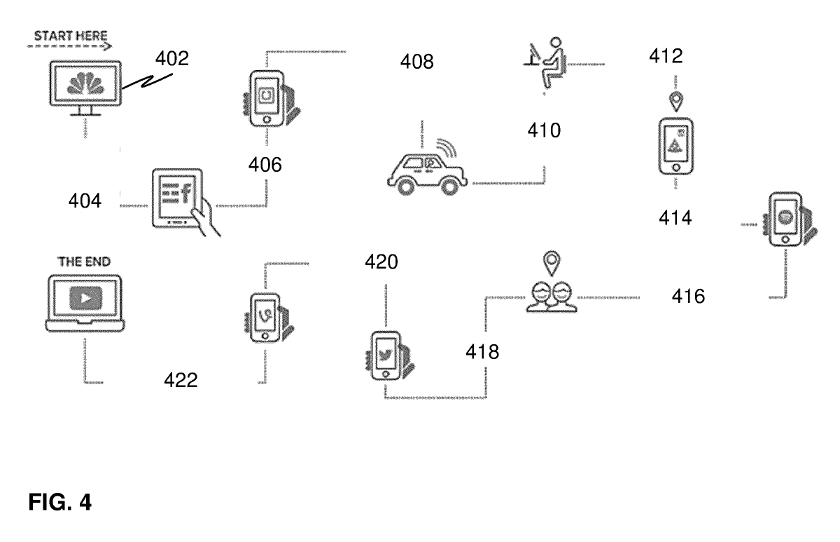

FIG. 4 illustrates different events the cross-platform monitoring solution in accordance with an embodiment of the present invention is capable of detecting and logging for analysis. As explained herein, the usage meter running in the electronic devices associated with a user, e.g. ‘Jim’, are arranged to observe, in the background, selected events including media exposure during Jim's day.

At 402, Jim enjoys his breakfast while watching the morning shown on television.

A smart tv or near-by other electronic device provided with e.g. audio and/or image/video capturing (through microphone and/or camera, respectively) and preferably also matching features therein stores an indication of the media exposure and optional contextual information (e.g. time, location, and/or sensor data such as accelerometer data indicative of motion or typically lack of motion during the breakfast). For audio, or sound, matching the device may have been provided with reference database based on which the captured audio or data derived therefrom, such as characteristic vectors or other characteristic data, is recognized responsive to match with certain reference.

Alternatively, the aforesaid matching may be executed remotely, e.g. by the arrangement or a third party server, based on data provided by the capturing electronic user device and including e.g. digital sound data or compressed data (such as vectorized data) derived therefrom enabling later matching procedures with reference data. In some embodiments, matching may involve cooperation between the electronic device and remote element such as the arrangement or third party server to recognize the content. The execution of matching tasks or related procedures may be shared and/or the element may offer the device external matching service the results of which (partial, intermediate or final recognition results) may be then returned to the terminal for further processing and/or storage, for instance.

At 404, Jim receives a message on his tablet including a proposition to do something after work.

The electronic devices such as the tablet may detect a received or sent message by the usage meter and log indication thereof for immediate or future transmission to the arrangement.

At 406, Jim orders a taxi or e.g. Uber™ ride on his smartphone.

The smartphone or other electronic device may indeed be observed in terms of data transfer in connection with e.g. different applications, browser or messaging solutions by the usage meter.

At 408, on his way to work, Jim hears on the radio that Blackhawks™ are playing tonight. Again, indication of media exposure is stored by the terminal with usage meter.

In addition to or instead of general recognition of e.g. media channel/network or certain program based on e.g. audio matching, speech recognition and/or speech detection (i.e. is there speech or not based on e.g. spectral analysis) may be applied at the device or at a remote location (arrangement or third party server) to the audio signal to determine the text conversion and thus the related semantic information of thereof.

At work 410, Jim calls his friend and purchases tickets to the game on his PC (personal computer).

Computers such as desktop, laptop or wearable computers may be observed as well. Also calls may be analyzed by the usage meter. Again, speech recognition, speech detection and/or audio matching are applicable either at the device or remotely.

At 412, Jim grabs a pre-game bite and posts pictures (digital photographs) to Instagram™ associated with the scene.

Also image or video data, potentially captured via the camera of the electronic device, may be observed and logged by the usage meter as already alluded to hereinbefore. Image analysis such as pattern recognition may be applied locally by the meter or remotely by the arrangement, for instance. Having regard to video with audio or pure sound clips, speech recognition, speech detection and/or audio matching may be applied.

Here and in connection with other logged events, contextual information such as location may be observed as well and associated with the logged data.

At 414, Jim walks to the area and gets into right mood by listening to the Spotify™.

Use of external services may be observed and logged even having regard to the delivered content (may be optionally identified using e.g. related metadata, audio matching or generally pattern recognition).

At 416, Jim purposefully shares his location and meets his friend.

The arrangement may detect the geographic vicinity of two devices associated with different users based on the observation data provided by the devices. Indication of such detection may be stored and utilized e.g. during analysis and creation of selected metrics. For example, user behavior may be investigated in terms of device usage including media exposure depending on the social context (e.g. alone vs. with a number of friends) of the user.

At 418, Jim uses Twitter™ to announce the first score.

Usage of social media services and applications may be observed.

At 420, Jim shares a clip of the game on Vine™. As mentioned hereinbefore, also capturing and/or sharing (transferring) of media clips such as video clips may be observed. The clips may be optionally analyzed to determine their content as discussed above.

At 422, after the game, Jim watches highlights of the game, time shifted and & on-demand. Usage of such services, and generally e.g. media streaming, including related media exposure may be observed and logged by the meter.

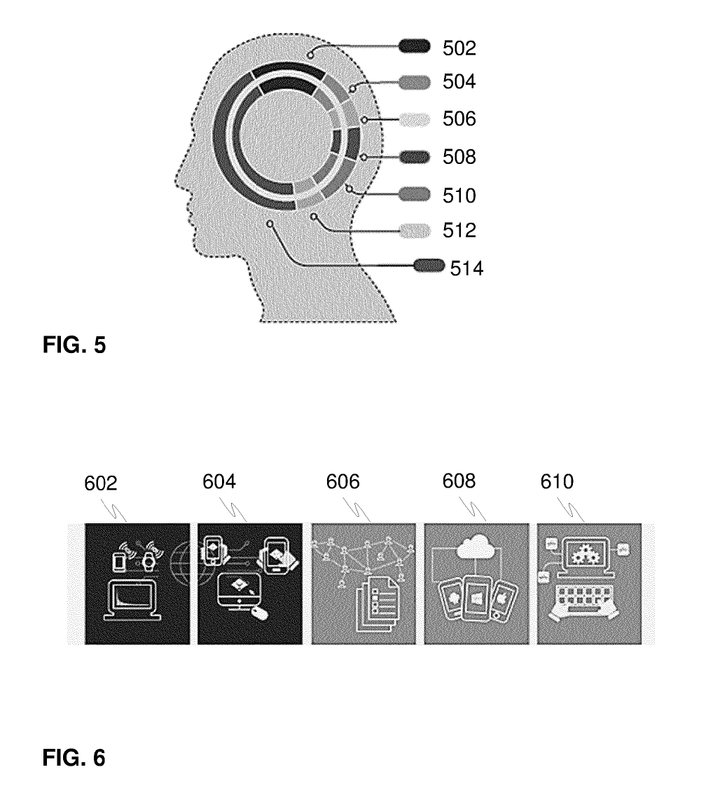

FIG. 5 visualizes, by way of example only, the concept of the suggested single-source measuring approach and related aspects for providing insight into the user's behavior including device and media usage.

Item 502 refers to observed and analyzed tablet and e-book behavior monitoring, which may involve app usage, device features and data usage, media streaming, and/or advertising.

Item 504 refers to smartphone or generally cellular phone or mobile terminal behavior monitoring, which may involve web and app usage, device features and data usage, and/or media streaming.

Item 506 refers to purchasing behaviors as the suggested solution may be arranged to track e/m-commerce transactions and e.g. purchasing profiles in the offline environment.

Item 508 refers to data matching, which may involve using Experian™ or e.g. other third party data to amend or cultivate user data e.g. via PII (personally identifiable information) available regarding the users.

Item 510 refers to computer or ‘PC’ behavior, which may involve observing e.g. desktop and laptop, potentially also wearable, computers, related web and app usage, device features and data usage, and/or media streaming.

Item 512 refers to offline media monitoring (e.g. television and radio via audio matching), which may involve tracking networks/channels/stations, television/radio shows, movies or other particular media or content items, and/or advertisements.

Item 514 refers to demographics, which may involve gathering holistic intelligence about the user's or ‘digital consumer’ s background such as age, gender, income, household size, marital status, race, ethnicity, and/or state.

FIG. 6 shows infographic of the utilized measurement methodology in accordance with an embodiment thereof.

The measurement data may be obtained from a plurality of sources such as multiple different user panels 602, 604 with reference to multiple groups of users in possession of one or more electronic devices provided with the usage meter possibly implemented as research application optionally bundled with other software and installed or taken into use on opt-in basis. As mentioned hereinbefore, at least one panel 602 may add to long tail metering and contain a greater number of users and related devices but provide less complete or credible data whereas one other panel 604 may be based on rigorously controlled and projectable, preferably always multi-screen, sample.

The calibration data 606, 608, 610 preferably covers the entire selected digital target audience across different demographic groups 606 (i.e. users or ‘consumers’, which may be obtained by separate surveys, for instance), platforms 608, and content 610 of market players (analytics, software development kits, developers, etc.).

The observation data gathered from the panelist devices may be, based on the calibration data, adapted (shifted or otherwise adjusted, for example) to represent a larger or different population by weighting the panelist data according to a selected weighting scheme. The calibration data enables gaining insight into the long tail and independent ground truth for ensuring demographic and behavioral representativeness of the measurements.

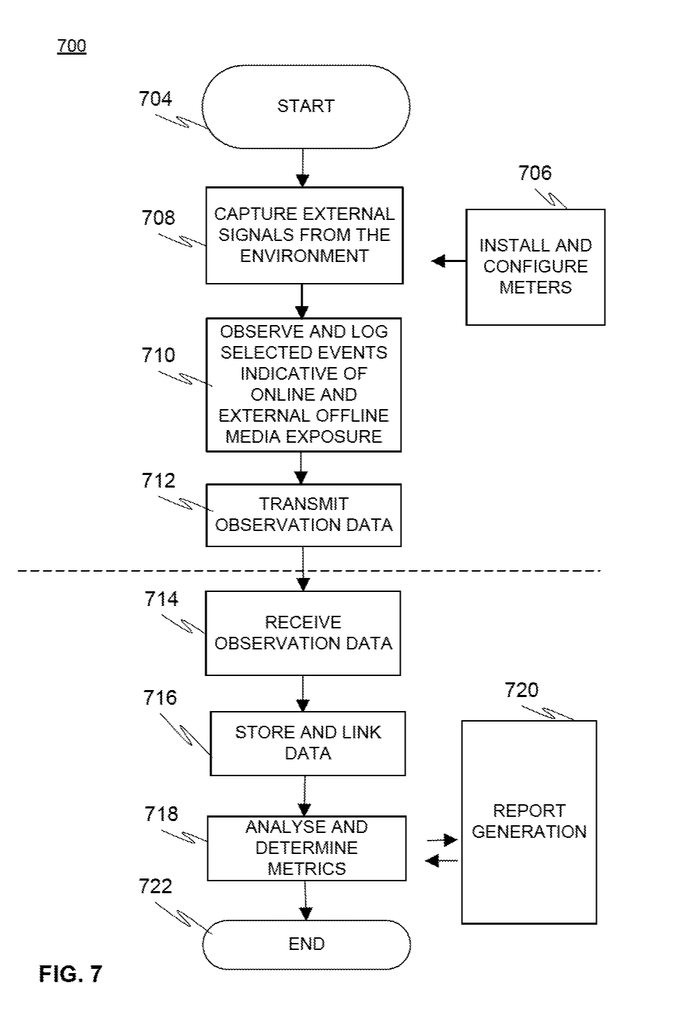

FIG. 7 is a flow diagram 700 disclosing an embodiment of a method in accordance with the present invention. Although the shown diagram contains a plurality of definite method items, in various other embodiments all the same items do not have to present. There may be additional method items as well not shown in the figure. Depending on the embodiment, some existing method items may be also realized as combined. Also the ordering of items may vary between the items and/or their execution may overlap considering e.g. items 708 and 710 discussed in more detail hereinbelow.

At method start-up 704, different preparatory tasks are executed. For example, one or more structural studies may be executed and surveys/questionnaires performed for establishing e.g. stratification quotas and calibration data for the concerned user (panel) study involving the automated measurements exploiting electronic, preferably personal, user devices.

At 706, the users acting as panelists may be recruited (e.g. measuring software with opt-in enrollment, bundled with other software the users downloaded). The metering software may be installed and configured at the electronic devices. Communication connections and links may be established and tested. The arrangement may be set up and configured to receive or fetch data from remote elements such as electronic user devices provided with usage meters for storage, processing and subsequent establishment of related deliverables such as reports.

At 708, the electronic device captures ambient data such as sound signals from the environment by one or more sensors such as microphones or other audio transducers.

The sensor data may be stored in the electronic device, optionally after processing such as compression and/or e.g. feature (vector) extraction, for the purposes of local and/or remote analysis.

At 710, the events of interest are observed, typically involving selected monitoring and detection activities, and stored e.g. in one or more log files. The electronic device running the usage meter is arranged to observe and log selected events involving user activity, particularly media exposure, and preferably also various other events providing contextual information such as location information, social information, movement or motion information, etc. In addition to online type media exposure based on e.g. application or web based exposure taking place through the device directly, offline phenomena and especially offline media exposure may be monitored by a number of sensors such as the aforesaid microphone and/or e.g. camera of the device.

The sensor data may be generally utilized in determining the context of the device and user. In particular, the sensor data may be applied to measure the user's exposure to offline media such as radio or television broadcasts, or e.g. audio-including and/or pictorial information including advertisements or other media in public places such as malls, crowd events, concerts, theaters, movie theaters, opera, sport events, etc.

In practice both items 708, 710 may be executed temporally substantially simultaneously, with overlap or at least alternately so that during observation and logging of internally occurring online events indicative of media exposure also the occurring offline events get duly registered with the help of sensors such as a microphone capturing the related data.

Item 712 refers to the transfer of the logged data to an embodiment of the arrangement. The electronic device may be configured to transmit the data in accordance with a selected scheduling scheme. The transmission may be periodic and occur optionally regularly or as otherwise clocked, for instance, and/or other more specific trigger conditions causing the transmission to occur may be defined and monitored. In some embodiments, the arrangement or other external element may be arranged to fetch or request data from the device. In the transmitted log, data having regard to a plurality of logged events may be jointly transferred, i.e. every single detected and logged event does not need to trigger transmission or does not have to be transferred in isolation. Instead, greater amount of data regarding multiple events may be first gathered and then transmitted upon proper moment in batches.

The dotted line indicates a general switchover from the terminal or generally electronic device side to the network and in particular, arrangement side in terms of main responsibility for executing the method items.

At 714, data such as observation data gathered in the electronic device(s) is received or generally, obtained at the arrangement. The data may be received in the form of a number of log files, for instance. The data may include contextual information such as location data or sensor information, for example. The data may identify the sending device while it preferably still preserves the associated user's anonymity in all those likely cases where knowing the users' absolute identity information such as name is not critical. However, in order to inspect cross-platform usage of devices, in view of e.g. media exposure, a capability to link data obtained from several devices but associated with a certain user together may be considered critical, whereupon the data preferably contains sufficient identification information such as a device id and/or user id (or generally any applicable profile information enabling distinguishing with a likelihood considered sufficient and optionally anonymously a certain user from other users, including e.g. behavioral, device, application, service and/or location data) to associate different data transmissions from the same device together and link the data of the several devices of the same user together as well.

At 716, the data is stored and preferably also associated (linked) appropriately in the light of the foregoing to facilitate its future analysis from the standpoint of single source user-level measuring and metrics.

At 718 and 720, the data is analyzed and selected deliverables (analyzed output data) are determined, respectively. The associated tasks may further include data weighting, calibration and/or validity checking. Calibration may occur e.g. on area or region such as country-by-country basis, utilizing survey and other behavioral data as calibration targets, for instance.

Generally, item 720 incorporates generation of desired deliverables such as digital reports embodied as computer-readable files that the users (clients) of the arrangement are keen on receiving. The deliverables may include a number of metrics and/or statistics derived at 718 based on the obtained and processed data having regard to a desired time span, for example. Media audience itself may be described as well as their cross-media consumption, related habits, preferences, dislikes, trends, etc.

The deliverables may be in predefined proprietary or more commonly used digital (file) format enabling a recipient to adjust its functions or operations including service or content personalization and e.g. (technical) system optimization (bandwidth, etc.) optionally automatically based thereon according to the used logic.

A number of control signals may be determined and sent based on the analysis to optimize application, service (running on e.g. web site or page), media or generally content item properties and/or their distribution properties (e.g. distribution platform selection, broadcast/distribution time optimization, quality/bandwidth optimization, etc.), electronic device features, and/or network functionalities (e.g. media routing or data transfer capacity).

At 722, the method execution is ended. Software for executing one or more of the method items, when run on a computer such as server or electronic terminal device, may be embodied in a non-transitory computer readable carrier medium, such as memory card, optical disc, or magnetic disc, or transmitted as a signal over a communications connection potentially involving a wired or wireless network.

The general scope of various aspects of the present invention is defined by the attached independent claims with appropriate national extensions thereof having regard to the applicability of the doctrine of equivalents.

1. An electronic arrangement for single-source cross-platform media measurements, comprising:
a communication interface arranged to receive observation data having regard to and at least partly determined at a plurality of electronic, preferably personal, devices of a number of users,
at least one user of said number being associated with multiple devices of said plurality, said multiple devices belonging to mutually different technological platforms including online platforms for providing media exposure and the multiple devices comprising a usage meter to observe selected events indicative of device usage comprising media exposure, wherein the usage meter of at least one of the multiple devices being further arranged to observe user exposure to media on one or more external offline media distribution platforms, and at least one of the multiple devices being arranged to transmit observation data comprising indications of the observations towards the arrangement,
at least one electronic database arranged to store the received observation data and user profile data linking the users with associated electronic devices, and
an analyzer functionally connected to said database and arranged to operate on the data therein to determine at least one data file indicative of user-level media exposure metrics incorporating metrics describing the at least one user's behavior including media exposure on multiple platforms, said platforms comprising one or more offline platforms, and multi-platform usage sessions involving two or more simultaneously or sequentially utilized platforms.

2. The arrangement of claim 1, wherein the observation data received comprises an indication of at least one element selected from the group consisting of: application, native application, digital service, web (World Wide Web) service, web site, web page, Internet, network, device feature, terminal feature, application feature, service feature, media item, content item, file, media streaming, phone usage, call, message, time, location, user demographics, data transfer, purchase or other financial transaction, operating system, HTTP data transfer, and HTTP(S) data transfer.

3. The arrangement of claim 1, arranged to establish or receive, preferably via the communication interface, at least one data element selected from the group consisting of: demographic data regarding one or more users, calibration or survey data to adapt the observation data or data derived therefrom, optionally the metrics, to represent a larger or different population of users, and rules or parameters determining the processing of observation data or derivation of the determined metrics.

4. The arrangement of claim 1, wherein the offline media distribution platforms include at least one platform selected from the group of: television, radio, and audio announcements such as indoor commercials.

5. The arrangement of claim 1, wherein the online platforms include at least one platform selected from the group consisting of: smartphone, computer, tablet, phablet, e-book reader, wristop computer, wearable computer, smart television, desktop computer, and laptop computer.

6. The arrangement of claim 1, wherein the analyzer is arranged to classify or identify the content, optionally online or offline media item, indicated in the observation data.

7. The arrangement of claim 1, wherein the analyzer comprises a speech detector to determine whether the observation data contains speech and/or a speech recognizer to determine the spoken language based on the observation data received.

8. The arrangement of claim 1, wherein the analyzer comprises a speech detector to determine whether the observation data contains speech and/or a speech recognizer to determine the spoken language based on the observation data received, and the analyzer is further arranged to identify or classify the platform or media item indicated in the observation data based on the speech detection and/or recognition result.

9. The arrangement of claim 1, wherein the analyzer comprises audio or image matcher configured to compare the observation data or data derived therefrom with reference data.

10. The arrangement of claim 1, wherein the analyzer is arranged to apply contextual information to the metrics determined and indicated by the data file, said contextual information including at least one context element selected from the group consisting of: motion or movement, absolute location, location type optionally indicative of home, out-of-home or work, social context indicative of being alone or with other people, and temporal context indicative of time.

11. The arrangement of claim 1, wherein the analysis of multi-platform usage sessions involves utilization of selected time interval relations, preferably Allen's intervals, to determine the usage sessions based on the observation data.

12. The arrangement of claim 1, wherein platform-level, optionally device-level, usage sessions are determined by the analyzer based on content-level, optionally application-level, usage sessions inferred from the observation data.

13. The arrangement of claim 1, wherein platform-level, optionally device-level, usage sessions are determined by the analyzer based on content-level, optionally application-level, usage sessions inferred from the observation data, and wherein multi-platform, optionally multi-device, usage sessions are determined by the analyzer based on the determined platform-level usage sessions.

14. The arrangement of claim 1, wherein analyzer is arranged to determine metrics describing at least element selected from the group consisting of: session length, number of platform switchovers during session, application sessions per device session, sessions per selected time window, sessions per day, interaction time per time window, interaction time per day, platform switchover parties, platform switchover direction, platform overlap, simultaneous usage of smartphone and tablet, simultaneous usage of at least two different technological platforms, simultaneous usage of online and offline platform, purchase behavior, and switchover between offline and online media.

15. The arrangement of claim 1, wherein the analyzer is arranged to determine causality or correlation between media exposure on multiple platforms, optionally in terms of temporal factors and/or content.

16. The arrangement of claim 1, wherein the analyzer is arranged to determine causality or correlation between the usage of different technological and/or media distribution platforms.

17. The arrangement of claim 1, wherein the analyzer is arranged to determine aggregate metrics indicative of behavior of a larger population of users based on the gathered user-level cross-platform observation data or related established user-level metrics, preferably including indication of the demographics of the population.

18. The arrangement of claim 1, wherein the analyzer is arranged to determine metrics describing switchover from platform to another during multi-platform session, preferably indicating related, optionally directional, transition probabilities between platforms.

19. The arrangement of claim 1, wherein the analyzer is arranged to determine metrics describing the usage overlap, preferably incorporating media exposure, between multiple platforms, optionally regarding substantially same or similar content.

20. The arrangement of claim 1, arranged to determine a control signal based on the data file containing the metrics, preferably output via the communication interface, wherein the control signal is optionally designed to adapt one or more features of an application, service, media campaign, content such as media file, web site, web page, or electronic device for accessing media.

21. The arrangement of claim 1, arranged to output said data file via the communication interface or user interface thereof.

22. An electronic device, optionally a smartphone or other portable user terminal, comprising
at least one sensor, preferably comprising a microphone, arranged to capture ambient data from the environment,
a usage meter to observe and log selected events indicative of device usage comprising media exposure taking place through the device, preferably including online media, wherein the usage meter is further arranged to observe and log user exposure to media on one or more external offline media distribution platforms, such as offline radio or television, based on the sensor data, preferably utilizing audio matching, speech detection and/or speech recognition, and
communication interface arranged to transmit observation data comprising the indications of the observations made and logged towards a remote arrangement over a communications connection.

23. A method for single-source cross-platform media measurements, to be performed by electronic arrangement comprising one or more at least functionally connected devices, comprising:
receiving, at the electronic arrangement, observation data having regard to and at least partly determined at a plurality of electronic, preferably personal, devices of a number of users,
at least one user of said number being associated with multiple devices of said plurality, said multiple devices belonging to mutually different technological platforms including online platforms for providing media exposure, and the multiple devices comprising a usage meter to observe selected events indicative of device usage comprising media exposure, wherein the usage meter of at least one of the multiple devices being further arranged to observe user exposure to media on one or more external offline media distribution platforms, at least one of the multiple devices being arranged to transmit observation data comprising indications of the observations towards the arrangement,
storing, in at least one electronic database, the received observation data and user profile data linking users with associated electronic devices, and
determining, by an analyzer functionally connected to said at least one database and arranged to operate on the data therein, at least one data file indicative of user-level media exposure metrics incorporating metrics describing the at least one user's behavior including media exposure on multiple platforms, said platforms comprising one or more offline platforms, and multi-platform usage sessions involving two or more simultaneously or sequentially utilized platforms.

24. A method for providing measurement data for single-source cross-platform media analysis arrangement, to be performed by an electronic user device, comprising:
capturing, by at least one sensor, ambient data from the environment,
observing and logging, by a usage meter of the device, selected events indicative of device usage comprising media exposure taking place via the device, further observing and logging indications of user exposure to media on one or more external offline media distribution platforms based on the sensor data, and
transmitting, by a communication interface of the electronic device, the logged data towards a remote arrangement over a communications connection.

25. (canceled)

26. (canceled)
